(19) United States
(12) Patent Application Publication
(10) Pub. No.: US 2023/0084031 A1
(43) Pub. Date: Mar. 16, 2023

(54) IMAGE-PROCESSING DEVICE AND DISPLAY-CONTROL METHOD FOR USE IN DISPLAY-WALL SYSTEM

(71) Applicant: Wistron Corp., New Taipei City (TW)

(72) Inventor: Wei-Lun LIU, New Taipei City (TW)

(21) Appl. No.: 17/714,620

(22) Filed: Apr. 6, 2022

Related U.S. Application Data
(60) Provisional application No. 63/241,570, filed on Sep. 8, 2021.
(60) Provisional application No. 63/241,079, filed on Sep. 6, 2021.

(30) Foreign Application Priority Data
Jan. 10, 2022 (TW) 111100928

(51) Int. Cl. G09G 3/20; G06F 3/04817

(52) U.S. Cl. CPC G09G 3/2092; G06F 3/04817; G09G 2360/18; G09G 2340/0407; G09G 2300/026

(57) ABSTRACT

An image-processing device for use in a display-wall system is provided. The display-wall system includes a plurality of display panels, and the display panels are connected to a display-control device, which is connected to the image-processing device. The image-processing device includes a storage device and a processor. The storage device stores an image-reorganizing program. The processor is configured to execute the image-reorganizing program to perform the following steps: receiving a video image; dividing the video image into a plurality of sub-images; reorganizing the sub-images corresponding to the display panels into a display frame; transmitting the display frame and a display-setting profile of each display panel to the display-control device; utilizing the display-control device to extract the sub-images corresponding to the display panels from the display frame according to the display-setting profile of each display panel, and to display each extracted sub-image on the corresponding display panel.

### CROSS REFERENCE TO RELATED APPLICATIONS

This application claims the benefits of U.S. Provisional Application No. 63/241,079, filed on Sep. 6, 2021, and U.S. Provisional Application No. 63/241,570, filed on Sep. 8, 2021, the entirety of which are incorporated by reference herein. This application also claims priority of Taiwan Patent Application No. 111100928, filed on Jan. 10, 2022, the entirety of which is incorporated by reference herein

### BACKGROUND OF THE DISCLOSURE

### Field of the Disclosure

The disclosure relates to display systems, and, in particular, to an image-processing device and a display-control method for use in a display-wall system.

### Description of the Related Art

A display-wall system may include a plurality of light-emitting diode (LED) display panels arranged in a homogenous or heterogeneous display layout. Because each LED panel has display directionality, when there is a large number of LED panels, in the heterogeneous display layout, the conventional display-wall system often requires a large number of image distributors and image cutters. In addition, because the display frame displayed on the conventional display-wall system needs to cover the entire range of the LED panels, the conventional display-wall system also requires an output device with a higher specification.

### BRIEF SUMMARY OF THE DISCLOSURE

In view of the above, an image-processing device and a display-control method for use in a display-wall system to solve the aforementioned problem.

In an exemplary embodiment, an image-processing device for use in a display-wall system is provided. The display-wall system includes a plurality of display panels, and the display panels are connected to a display-control device, and the display-control device is connected to the image-processing device. The image-processing device includes a storage device and a processor. The storage device is configured to store an image-reorganizing program. The processor is configured to execute the image-reorganizing program to perform the following steps: receiving a video image; dividing the video image into a plurality of sub-images; reorganizing the sub-images corresponding to the display panels into a display frame; transmitting the display frame and a display-setting profile of each display panel to the display-control device; utilizing the display-control device to extract the sub-images corresponding to the display panels from the display frame according to the display-setting profile of each display panel, and to display each extracted sub-image on the corresponding display panel.

In another exemplary embodiment, a display-control method for use in an image-processing device is provided. The method includes the following steps: receiving a video image to be displayed on a plurality of display panels, wherein the display panels are connected to a display-control device; dividing the video image into a plurality of sub-images; reorganizing the sub-images corresponding to the display panels into a display frame; transmitting the display frame and a display-setting profile of each display panel to the display-control device; and utilizing the display-control device to extract the sub-images corresponding to the display panels from the display frame according to the display-setting profile of each display panel, and displaying each extracted sub-image on the corresponding display panel.

### BRIEF DESCRIPTION OF THE DRAWINGS

The disclosure can be more fully understood by reading the subsequent detailed description and examples with references made to the accompanying drawings, wherein:

FIG. 1A is a block diagram of a display-wall system in accordance with an embodiment of the disclosure;

FIGS. 1B-1C are diagrams of the display-wall system in accordance with the embodiment of FIG. 1A.

FIG. 2 is a diagram of the video image, display frame, and the sub-image displayed on each display panel in accordance with an embodiment of the disclosure;

FIG. 3 is a flow chart of a display-control method in accordance with an embodiment of the disclosure;

FIG. 4 is a diagram of converting a display frame into an encoding frame in accordance with an embodiment of the disclosure;

FIG. 5 is a flow chart of a display-control method in accordance with another embodiment of the disclosure; and

FIGS. 6A-6D are diagrams of the graphical user interface of the image-reorganizing program in accordance with an embodiment of the disclosure.

### DETAILED DESCRIPTION OF THE DISCLOSURE

The following description is made for the purpose of illustrating the general principles of the disclosure and should not be taken in a limiting sense. The scope of the disclosure is best determined by reference to the appended claims.

It should be understood that the words “comprising”, “including” and the like used in this specification are used to indicate the existence of specific technical features, values, method steps, operation processes, elements and/or components, but do not It is not excluded that further technical features, values, method steps, work processes, elements, components, or any combination of the above may be added.

The use of terms such as “first”, “second”, and “third” in claims is used to modify elements in the claims, and is not used to indicate that there is a priority order, antecedent relationship, or Is an element preceded by another element, or a chronological order when performing a method step, only used to distinguish elements with the same name.

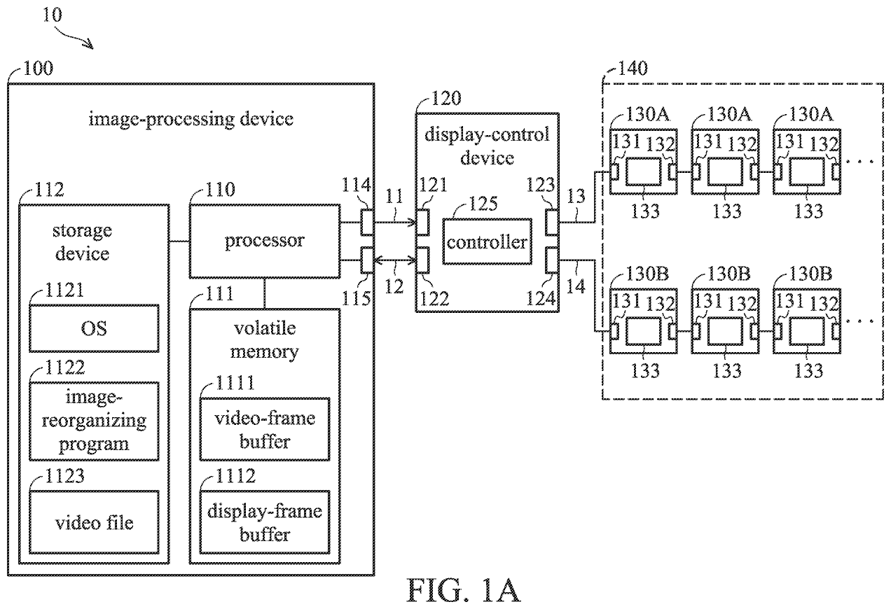

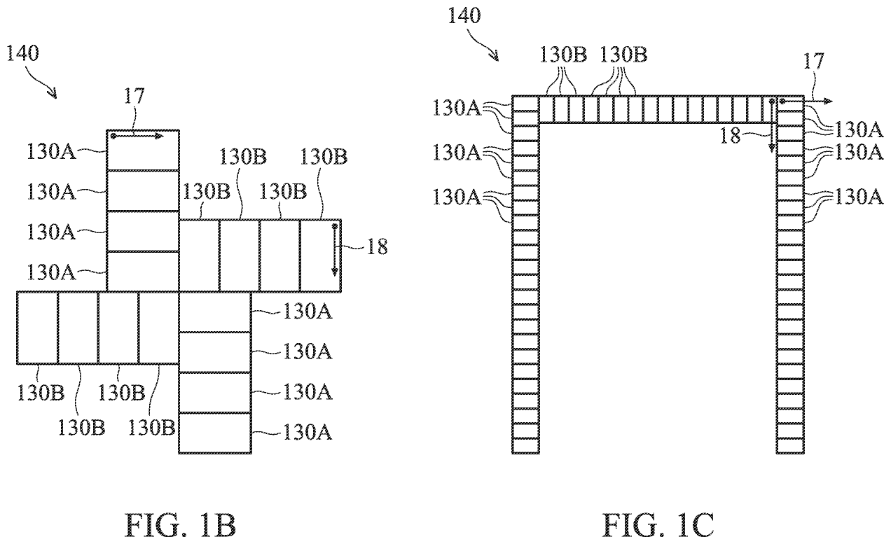

FIG. 1A is a block diagram of a display-wall system in accordance with an embodiment of the disclosure. FIGS. 1B-1C are diagrams of the display-wall system in accordance with the embodiment of FIG. 1A.

The display-wall system 10 may include an image-processing device 100, a display-control device 120, and a display wall 140. The image-processing device 100 is connected to the display-control device 120 through an image-transmission channel 11 and a data-transmission channel 12. The image-processing device 100 may be a personal computer or a server, which has an image-playback capability and an image-output capability. For example, the image-processing device 100 can decode and play video files of different formats, and can process the decoded video images to obtain the display frames to be displayed on each of the display panels 130A and 130B in the display wall 140. The image-processing device 100 may transmit the display frames and display-setting profiles of the display wall 140 to the display-control device through the image-transmission channel 11 and data-transmission channel 12 corresponding to the transmission ports 114 and 115, respectively.

As shown in FIG. 1A, the image-processing device may include a processor 110, a volatile memory 111, and a storage device 112. The processor 110, for example, may be a central processing unit (CPU), a general-purpose processor, etc., but the disclosure is not limited thereto. The volatile memory 111 may be implemented by a dynamic random access memory (DRAM) or a static random access memory (SRAM), but the disclosure is not limited thereto.

The volatile memory 111 may include a video-frame buffer 1111 and a display-frame buffer 1112. The video-frame buffer 1111 may be configured to temporarily store the video images obtained by the processor 110 performing video decoding on the video file 1123, and the display-frame buffer 1112 may be configured to temporarily store the display frames to be transmitted to the display-control device 120, wherein each of the display frames may include the sub-image to be displayed on each display panel. It should be noted that both the video-frame buffer 1111 and the display-frame buffer 1112 are designed as ping-pong buffers, which means that each of the video-frame buffer 1111 and the display-frame buffer 1112 may include a first portion and a second portion. If the current operation performs a store operation on the first portion, the processor 110 will perform a read operation from the second portion. Similarly, if the current operation performs a read operation on the first portion, the processor 110 will perform a write operation on the second portion, so as to avoid the situation of broken images.

The storage device 112 may be configured to store an operating system (OS) 1121, an image-reorganizing program 1122, and a video file 1123. The operating system 1121, for example, may be Windows, Linux, MacOS, etc., but the disclosure is not limited thereto. The image-reorganizing program 1122 may be configured to reorganize and arranges each sub-image in the video image to obtain a display frame, which is stored in the display-frame buffer 1112. The video file 1123, for example, may be an image-compression file, a video-streaming file, etc., and may have different video-compression formats, such as MPG, H.264, etc., but the disclosure is not limited thereto.

The display-control device 120 can receive the display frame and the display-setting profile of the display wall 140 from the image-processing device 100 through the image-transmission channel 11 and the data-transmission channel 12 corresponding to the transmission port 121 (e.g., a DisplayPort interface, a HDMI interface, a VGA interface, etc.) and transmission port 122 (e.g., a USB port which support USB 2.0 or above), respectively. In some embodiments, the transmission ports 114 and 115 may be integrated into one USB Type-C transmission port, and the image-transmission channel 11 and data-transmission channel 12 can be integrated into one, but the disclosure is not limited thereto.

The controller 125 of the display-control device 120 may know information about the orientation, resolution, and position (i.e., the details will be described later) of each of the display panels 130A and 130B in the display wall 140, and display each sub-image in the display frame on the corresponding display panel 130A or 130B according to the aforementioned information. For example, the controller 125 may be implemented by a general-purpose processor or a microprocessor, but the disclosure is not limited thereto.

The display wall may include a plurality of display panels 130A and 130B, that are arranged in a predetermined manner, such as the windmill shape shown in FIG. 1B or the arc shape shown in FIG. 1C, but the disclosure is not limited to the heterogeneous display layout shown in FIG. 1B and FIG. 1C. The display panels 130A and 130B can also be arranged in the homogeneous display layout (i.e., both using the same screen-scanning direction).

For example, the screen-scanning directions of the display panels 130A and 130B are both raster scans, and this means that scanning is performed line by line from left to right and from top to bottom. When some of the display panels have a rotation angle, such as the display panel 130B having a rotation angle of 90 degrees, the display wall 140 will include two or more screen-scanning directions, as shown in the scanning directions 17 and 18 in FIG. 1B and FIG. 1C.

In addition, the display panels 130A and 130B are connected to the output ports 123 and 124 of the display-control device 120 in series, respectively, such as the image-data channels 13 and 14. In some embodiments, the image-data channels 13 and 14 can be implemented by, for example, RJ45, USB, or DisplayPort interfaces that can realize serial connection, but the disclosure is not limited thereto. For example, each of the display panels 130A and 130B is the smallest unit for displaying image data, and each of the display panels 130A and 130B includes an input port 131, an output port 132, and an LED panel 133.

For example, the display panels 130A and 130B may receive display frames from the display-control device 120 through corresponding image-data channels (e.g., RJ45 network lines may be used), and display the corresponding sub-images in the display frame. For example, the image data transmitted by the image-data channels 13 and 14 may include sub-images to be displayed on the display panels 130A and 130B, respectively. The display panels 130A and 130B may include network controllers to identify the device identifier (Device ID) in the image data transmitted by the image-data channels 13 or 14. If the image data does not include the sub-image of the local display panels 130A or 130B, the sub-image will be output to the next display panel 130A or 130B through the output port of the local display panel 130A or 130B.

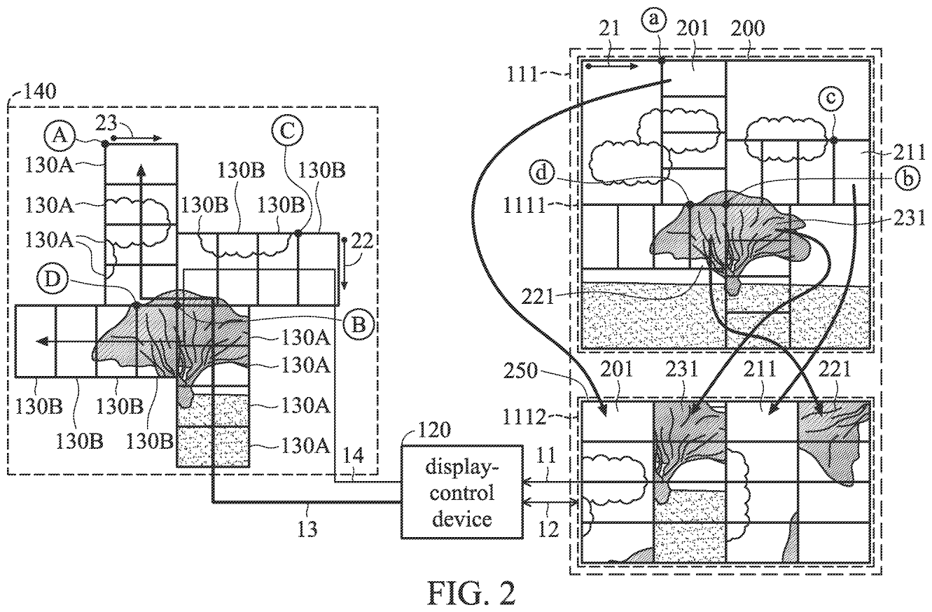

FIG. 2 is a diagram of the video image, display frame, and the sub-image displayed on each display panel in accordance with an embodiment of the disclosure. Please refer to FIG. 1A and FIG. 2.

In an embodiment, the video image 200 obtained by the processor of the image-processing device 100, which performs video decoding on the video file 1123, is stored in the video-frame buffer 1111. The video image 200 can be divided into a plurality of sub-images, such as sub-images 201, 211, 221, and 23, etc., For example, sub-image 201 (corresponding to position (a)) and the sub-image (e.g., the first region) placed horizontally below it, and sub-image 231 (corresponding to position (b)) and the sub-image (e.g., the second region) placed horizontally below it are displayed on the display panels 130A. Sub-image 211 (corresponding to position (c)) and the sub-image (e.g., the third region) and the sub-image placed vertically on the left side thereof, and sub-image 221 (corresponding to position (d)) and the sub-image placed vertically on the left side thereof are displayed on the display panels 130B.

The image-reorganizing program 1122 executed by the processor 110 may reorganize and arrange the sub-images in the video image 200 that will be displayed on the display panels 130A and 130B to obtain a display frame 250, wherein the display frame 250 is stored in the display-frame buffer 1112. In brief, there are 8 display panels 130A and 8 display panels 130B in FIG. 2, so there is a total of 16 sub-images, and each sub-image needs to be displayed on each of the display panels 130A and 130B. It should be noted that the disclosure is not limited to the aforementioned number of display panels 130A and 130B, and those skilled in the art of the present application can adjust the number of display panels 130A and 130B in the display wall 140 according to actual needs.

The image-reorganizing program 1122 may crop the sub-image corresponding to the position of each of display panels 130A and 130B according to the display-setting profile of the display wall 140, and reorganize the cropped sub-images to obtain the display frame 250. Each of the display panels 130A may receive the corresponding sub-image from the display-control device 120 through the image-data channel 13, and each of the display panels 130B may receive the corresponding sub-image from the display-control device 120 through the image-data channel 14.

In an embodiment, the display-setting profile of each of display panels 130A and 130B in the display wall 140 is shown as follows:

```
  #Define Total_LED_Board n
  struct LedBoard_Info
  {
    BYTE PHY_ID;
    BYTE ID;
    INT X;
    INT Y;
    INT Width;
    INT Height;
    INT Rotate;
    INT Rotate_Direction;
    INT LedBoardWidth;
    INT LedBoardHeight;
    INT FB_X;
    INT FB_Y;
    INT FB_Width;
    INT FB_Height;
};
```

where Total_LED_Board denotes the number of display panels; PHY_ID denotes an identifier of the output port (i.e., physical port) of the display-control device 120 to which the display panel is connected; ID denotes the serial-connection position, which means the position number of the display panel in the serial connection; X and Y respectively denote X-axis and Y-axis coordinates of the start point of the sub-image with respect to the video image 200 in the video-frame buffer 1111 (e.g., based on coordinates of the upper-left vertex of the sub-image); Width and Height denote the pixel width and pixel height of the sub-image to be displayed, respectively; Rotate denotes the rotation angle of the display panel relative to the video image; Rotate_Direction denotes the rotation direction of the display panel relative to the video image; LedBoardWidth and LedBoardHeight denote the pixel width and pixel height of the display panel, respectively; FB_X and FB_Y respectively denote the X-axis and Y-axis coordinates of the start point when copying the sub-image of the display panel to the display-frame buffer 1112 (e.g., based on the upper-left vertex of the sub-image); FB_Width and FB_Height respectively denote the pixel width and pixel height of the sub-image of the display panel stored in the display-frame buffer 1112.

Referring to FIG. 2, assuming that the resolution of the video image 200 is 1080 (horizontal)×1080 (vertical) pixels, and the resolution of each of display panels 130A and 130B is 240 (horizontal)×135 (vertical) pixels. The content of the display-setting profile of the display panel 130A at position (a) is shown as follows:

PHY_ID=0;

ID=8;

X=300;

Width=240;

Height=135;

Rotate=0;

Rotate_Direction=0;

LedBoardWidth=240;

LedBoardHeight=135;

FB_X=0;

FB_Y=0;

FB_Width=240;

FB_Height=135;

For example, the PHY IDs of the output ports 123 and 124 of the display-control device 120 are respectively 0 and 1, and the serial-number ID of the display panels 130A and 130B in the image-data channels 13 and 14 are 1 to 8 in sequence. Therefore, the display panel 130A at position (a) is connected to the image-data channel 13 of the output port 123, so its PHY_ID is 0, and it is the last display panel in the image-data channel 13, so its serial-number ID is 8. The coordinates (X, Y) of the upper-left vertex of the sub-image 201 in the video image 200 stored in the video-frame buffer 1111 are (300, 0), and the pixel width “Width” and pixel height “Height” of the sub-image to be displayed are respectively 240 and 135. That is, the position of the coordinates (300, 0) of the video-frame buffer 1111 is used as the start point, and a sub-image with a pixel width and pixel height of 240×135 is obtained.

In addition, since the scanning directions of the sub-image 201 relative to the video image 200 are the same, there is no need to rotate the sub-image 201, and thus the parameter Rotate=0. When the rotation angle is 0, the setting of the parameter Rotate_Direction can be ignored. Since the pixel width and pixel height of the display panel 130A are respectively 240 and 135, the parameters LedBoardWidth and LedBoardHeight are respectively 240 and 135. In addition, the coordinates of the upper-left vertex of the sub-image 201 in the display-frame buffer 1112 are (0, 0), and thus (FB_X, FB_Y)=(0, 0). In this embodiment, the resolution of the display panel 130A is the same as that of the sub-image to be displayed, so the parameters FB_Width and FB_Height can be set to 240 and 135, respectively.

Similarly, the content of the display-setting profile of the display panel 130A at position (b) is shown as follows:

PHY_ID=0;

ID=4;

X=540;

Y=540;

Width=240;

Height=135;

Rotate=0;

Rotate_Direction=0;

LedBoardWidth=240;

LedBoardHeight=135;

FB_X=240;

FB_Y=0;

FB_Width=240;

FB_Height=135;

For example, the display panel 130A at position (B) is connected to the image-data channel 13 of the output port 123, so the PHY_ID of the display panel 130A is 0, and it is the fourth display panel in the image-data channel 13, so its serial-number ID is 4. The coordinates of the upper-left vertex of the sub-image 231 (i.e., corresponding to position (b) in the video image 200 stored in the video-frame buffer 1111 are (540, 540), and the pixel width “Width” and pixel height “Height” of the sub-image to be displayed are respectively 240 and 135. That is, the position of the coordinates (540, 540) of the video-frame buffer 1111 is used as a start point, and a sub-image with a pixel width and pixel height of 240×135 is obtained.

In addition, since the scanning directions of the sub-image 231 relative to the video image 200 are the same, there is no need to rotate the sub-image 231, and thus the parameter Rotate=0. When the rotation angle is 0, the setting of the parameter Rotate_Direction can be ignored. Since the pixel width and pixel height of the display panel 130A are respectively 240 and 135, the parameters LedBoardWidth and LedBoardHeight are respectively 240 and 135. In addition, the coordinates of the upper-left vertex of the sub-image 231 in the display-frame buffer 1112 are (240, 0), and thus (FB_X, FB_Y)=(240, 0). In this embodiment, the resolution of the display panel 130A is the same as that of the sub-image to be displayed, so the parameters FB_Width and FB_Height can be set to 240 and 135, respectively.

The content of the display-setting profile of the display panel 130A at position (C) is shown as follows:

PHY_ID=1;

ID=8;

X=945;

Y=300;

Width=135;

Height=240;

Rotate=90;

Rotate_Direction=0;

LedBoardWidth=240;

LedBoardHeight=135;

FB_X=480;

FB_Y=0;

FB_Width=240;

FB_Height=135;

For example, the display panel 130B at position (C) is connected to the image-data channel 14 of the output port 124, so the PHY_ID of the display panel 130B is 1, and it is the eighth display panel in the image-data channel 13, so its serial-number ID is 8. The coordinates of the upper-left vertex of the sub-image 211 (i.e., corresponding to position (c) in the video image 200 stored in the video-frame buffer 1111 are (945, 300), and the pixel width “Width” and pixel height “Height” of the sub-image to be displayed are respectively 135 and 240. That is, the position of the coordinates (945, 300) of the video-frame buffer 1111 is used as a start point, and a sub-image with a pixel width and pixel height of 135×240 is obtained.

In addition, since the scanning directions of the sub-image 211 is at a 90-degree angle with respect to the scanning direction of the video image 200, it needs to rotate the sub-image 231 counterclockwise (leftward), and thus the parameter Rotate=90, and the parameter Rotate_Direction=0. Since the pixel width and pixel height of the display panel 130A are respectively 240 and 135, the parameters LedBoardWidth and LedBoardHeight are respectively 240 and 135. In addition, the coordinates of the upper-left vertex of the sub-image 211 in the display-frame buffer 1112 are (480, 0), which means it is on the right side of the sub-image 231, and thus (FB_X, FB_Y)=(480, 0). In this embodiment, the resolution of the display panel 130A is the same as that of the sub-image to be displayed, so the parameters FB_Width and FB_Height can be set to 240 and 135, respectively.

The content of the display-setting profile of the display panel 130B at position (D) is shown as follows:

PHY_ID=1;

ID=4;

X=405;

Y=540;

Width=135;

Height=240;

Rotate=90;

Rotate_Direction=0;

LedBoardWidth=240;

LedBoardHeight=135;

FB_X=720;

FB_Y=0;

FB_Width=240;

FB_Height=135;

For example, the display panel 130B at position (D) is connected to the image-data channel 14 of the output port 124, so the PHY_ID of the display panel 130B is 1, and it is the fourth display panel in the image-data channel 14, so its serial-number ID is 4. The coordinates of the upper-left vertex of the sub-image 221 (i.e., corresponding to position (d) in the video image 200 stored in the video-frame buffer 1111 are (405, 540), and the pixel width “Width” and pixel height “Height” of the sub-image to be displayed are respectively 135 and 240. That is, the position of the coordinates (405, 540) of the video-frame buffer 1111 is used as a start point, and a sub-image with a pixel width and pixel height of 135×240 is obtained.

In addition, since the scanning directions of the sub-image 221 is at a 90-degree angle with respect to the scanning direction of the video image 200, it needs to rotate the sub-image 231 counterclockwise (leftward), and thus the parameter Rotate=90, and the parameter Rotate_Direction=0. Since the pixel width and pixel height of the display panel 130A are respectively 240 and 135, the parameters LedBoardWidth and LedBoardHeight are respectively 240 and 135. In addition, the coordinates of the upper-left vertex of the sub-image 221 in the display-frame buffer 1112 are (720, 0), which means it is on the right side of the sub-image 221, and thus (FB_X, FB_Y)=(720, 0). In this embodiment, the resolution of the display panel 130B is the same as that of the sub-image to be displayed, so the parameters FB_Width and FB_Height can be set to 240 and 135, respectively.

Accordingly, the display-control device 120 may transmit each sub-image to the corresponding display panel 130A or 130B through the image-data channels 13 and 14 corresponding to the output ports 123 and 124 according to the display settings of each of display panels 130A and 130B, as shown in FIG. 2.

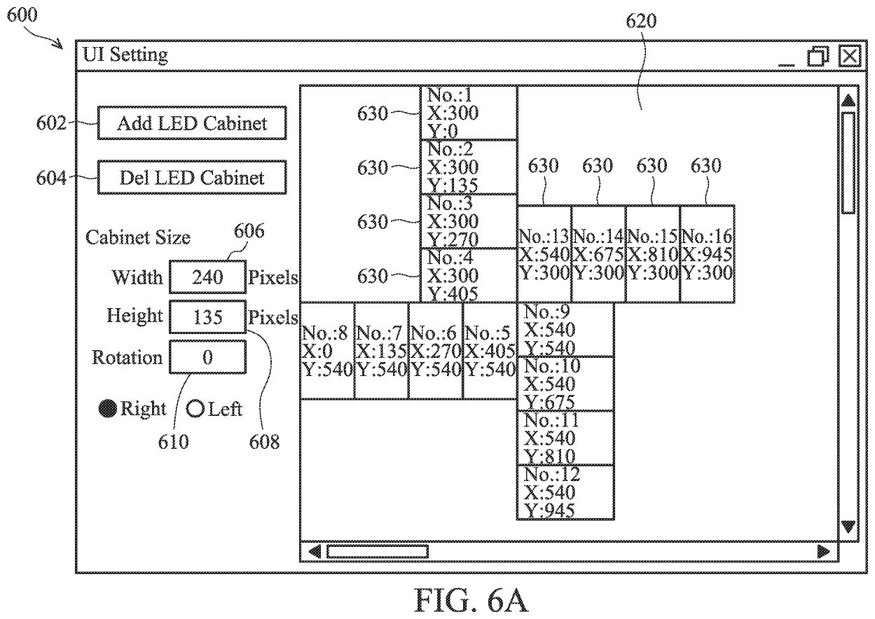

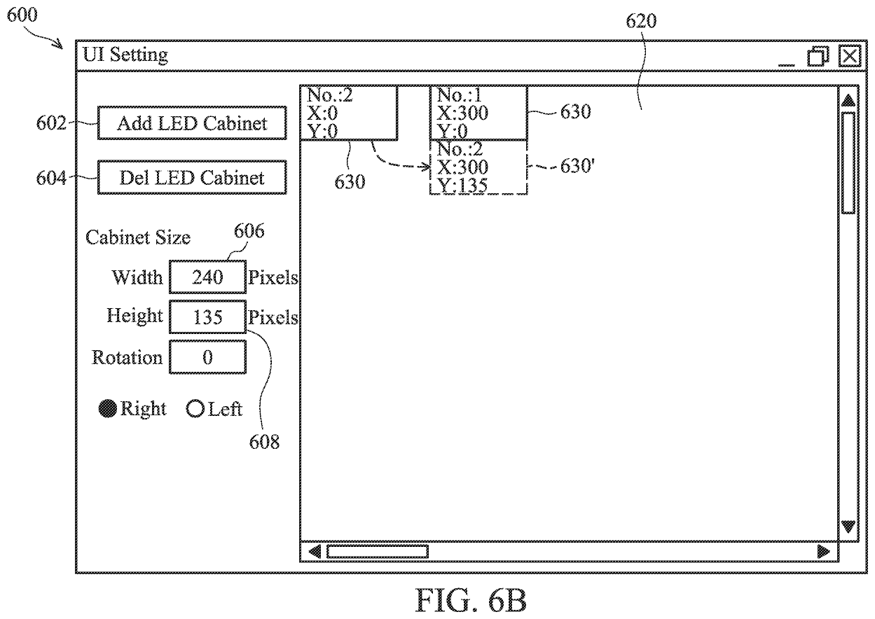

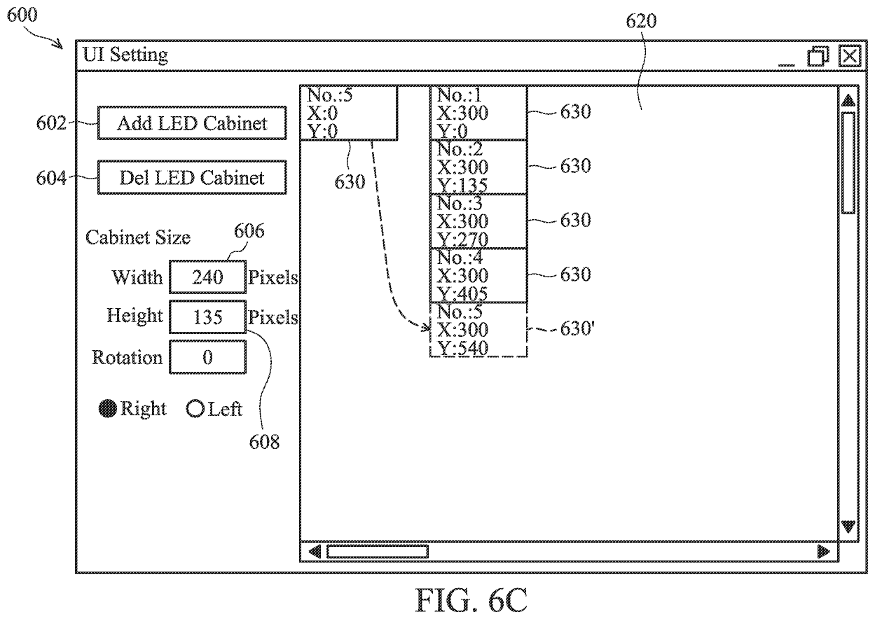

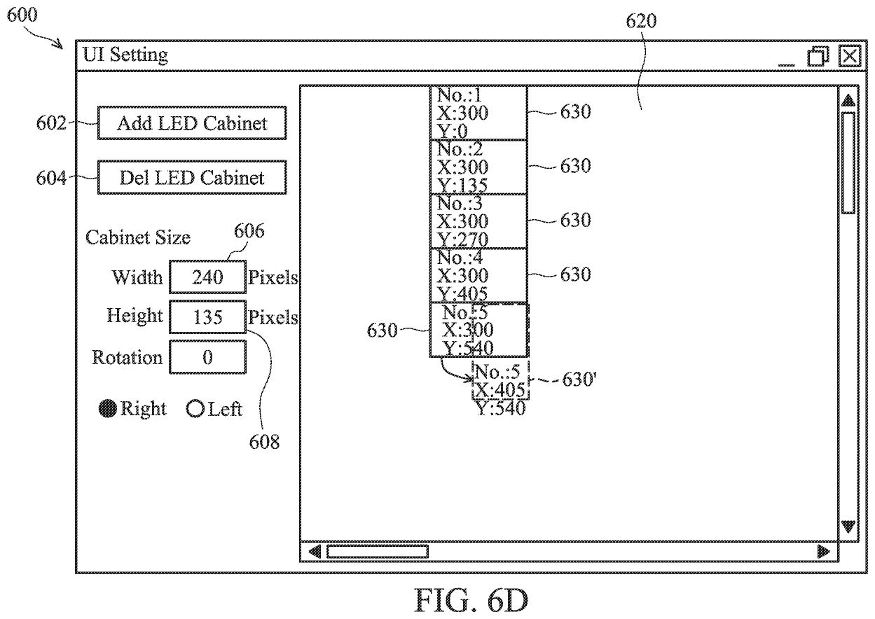

In an embodiment, the display-setting profile of each of display panels 130A and 130B in the display wall 140, for example, may be generated by a graphical user interface of the image-reorganizing program 1122, manually filled, or obtained by automatic image identification by a mobile device, but the disclosure is not limited thereto. The details of the graphical user interface of the image-reorganizing program 1122 will be described in the embodiments of FIGS. 6A-6D.

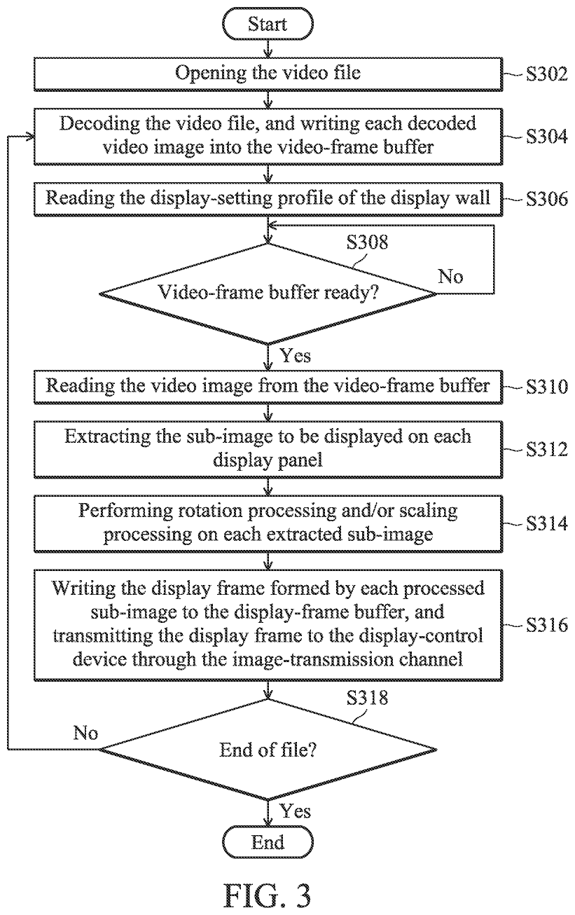

FIG. 3 is a flow chart of a display-control method in accordance with an embodiment of the disclosure. Please refer to FIG. 1 to FIG. 3.

In step S302, the video file 1123 is opened. For example, the video file 1123, may be an image-compression file, a video-streaming file, etc., and may have different video-compression formats, such as MPG, H.264, etc., but the disclosure is not limited thereto.

In step S304, the processor 110 decodes the video file 1123, and writes each decoded video image into the video-frame buffer 1111. For example, FIG. 2 has shown that the video image 200 can be stored in the video-frame buffer 1111.

In step S306, the processor 110 reads the display-setting profile of the display wall 140. For example, each of display panels 130A and 130B in the display wall 140 may have a corresponding display-setting profile, the details of which can be referred to the aforementioned embodiments. In addition, the display-setting profile may be generated by the graphical user interface of the image-reorganizing program 1122, and stored in the storage device 112 in advance. It should be noted that the execution order of the flow in FIG. 3 is not limited to the sequence shown in FIG. 3, and step S306 can be executed in different sequences, for example, it can be executed before step S302, or after step S304, depending on the actual situation.

In step S308, the processor determines whether the video-frame buffer 111 is ready. When the processor 110 determines that the video-frame buffer 1111 is ready, step S310 is performed. When the processor 110 determines that the vide-frame buffer 1111 is not ready, the flow goes back to step S308 to wait for the video-frame buffer 1111 to be ready.

In step S310, the processor 110 reads the video image from the video-frame buffer 1111. For example, the video-frame buffer 1111 is designed as ping-pong buffers, which means that each of the video-frame buffer 1111 may include a first portion and a second portion. If the current operation performs a store operation on the first portion, the processor 110 will perform a read operation from the second portion. Similarly, if the current operation performs a read operation on the first portion, the processor 110 will perform a write operation on the second portion, so as to avoid the situation of broken images.

In step S312, the sub-image to be displayed on each display panel is extracted from the video image. For example, as shown in FIG. 2, some of the sub-images in the video image 200 correspond to the display panels 130A and 130B, so the processor 110 extract the sub-image to be displayed on each of display panels 130A and 130B from the video image 200.

In step S314, rotation processing and/or scaling processing is performed on each extracted sub-image. For example, if the resolution of each sub-image is the same as that of the display panels 130A and 130B, no scaling processing is required. If the resolution of each sub-image is different from that of the display panels 130A and 130B, the processor 110 will scale the sub-image to match the resolution of the display panels 130A and 130B. In addition, because the scanning direction of the display panels 130B is different from that of the video image 200, the processor 110 needs to perform rotation processing on the sub-images corresponding to the display panels 130B, such as rotating the sub-images counterclockwise (leftward) by 90 degrees, as shown in FIG. 2.

In step S316, the display frame formed by the processed sub-images is written to the display-frame buffer 1112, and the display frame is transmitted to the display-control device 120 through the image-transmission channel 11. For example, the display frame 250 shown in FIG. 2 is formed by the sub-images corresponding to each of the display panels 130A and 130, and it does not include the sub-images that does not correspond to each of the display panels 130A and 130B. Therefore, the resolution of the display frame 250 is smaller than that of the video image 200, so the bandwidth required for transmitting the image data between the image-processing device 100 and the display-control device 120 can be saved.

In step S318, it is determined whether the end of file (EoF) has been reached. If the end of file has been reached, the flow ends. If the end of file has not been reached, the flow goes back to step S304.

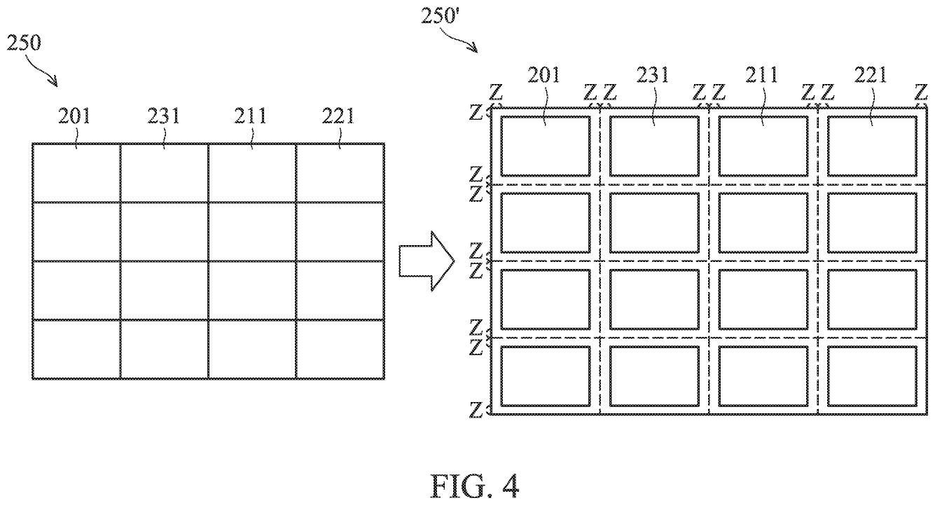

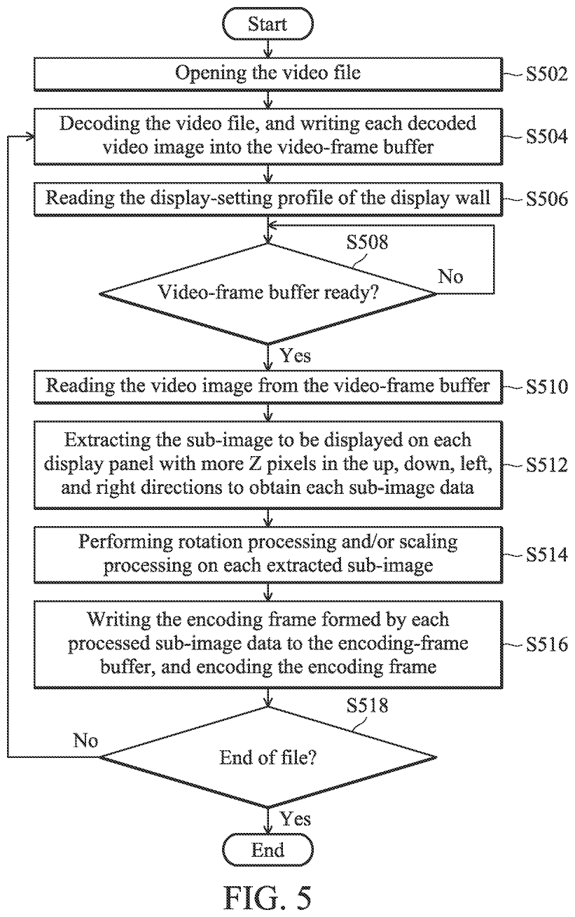

FIG. 4 is a diagram of converting a display frame into an encoding frame in accordance with an embodiment of the disclosure. FIG. 5 is a flow chart of a display-control method in accordance with another embodiment of the disclosure. Please refer to both FIG. 4 and FIG. 5.

In an embodiment, the image-processing device 100 may support the function of non-real-time playback. For example, the image-processing device 100 may obtain the video file 1123 (or a real-time playback video stream) to be displayed on the display-wall system 10 in advance, and the convert the video file 1123 (or the real-time playback video stream) into another video file for use in the display-wall system 10. For example, the sub-images in the video frame 250 are properly arranged, and each sub-image and its left/right sub-images may not be adjacent sub-images in the original video image. In addition, if the video file 1123 uses a video encoding standard such as H.264, the display frame 250 will be divided into a plurality of macroblocks for block encoding/decoding, and deblocking process will result in blurriness of the decoded frame. Accordingly, the processor 110 may extract Z more pixels (e.g., Z=16, but not limited) in the up, down, left, and right directions of each sub-image of the display frame 250 through the method shown in FIG. 4, and encode the obtained sub-image data into the encoding frame 250′, and perform video encoding on the encoding frame 250′ to obtain a new video file, which means that the original general video file 1123 can be converted into a new video file for the display-wall system 10. Therefore, the new video file is available for non-ream-time playback.

For example, the flow in FIG. 5 is similar to that in FIG. 3, and the difference is that the flow in FIG. 5 is for non-real-time playback. For example, in step S512, the processor 110 extracts the sub-image to be displayed on each display panel with more Z pixels in the up, down, left, and right directions to obtain each sub-image data.

In addition, in step S516, the processor 110 writes the encoding frame formed by each processed sub-image data to the encoding-frame buffer, and performs video encoding to the encoding frame to obtain the new video file. The details of other steps in FIG. 5 can be referred to the embodiment in FIG. 3, and thus will not be repeated here.

In some embodiments, when the processor performs video decoding to the new video file to obtain the decoded frame, the processor 110 may crop out the sub-image corresponding to each display panel with more Z pixels in the up, bottom, left, and right directions. If the resolution of each sub-image is X (horizontal)*Y (vertical), it means that the size of the cropped region is (X+2Z)*(Y+2Z). Then, the display-control device 120 may frame and select each sub-image from each cropped region according to the display-setting profile of the display wall 140, and display each sub-image on the corresponding display panel. It should be noted that the associated parameters (e.g., X, Y, Width, Height, FB_X, FB_Y, FB_Width, and FB_Height) in the display-setting profile of each display panel in the display wall 140 also need to be adjusted accordingly. Through the aforementioned manner, the embodiments of the disclosure can avoid the aforementioned problem of blurriness between the sub-images.

FIGS. 6A-6D are diagrams of the graphical user interface of the image-reorganizing program in accordance with an embodiment of the disclosure. Please refer to FIG. 1 and FIGS. 6A-6D.

As shown in FIG. 6A, the graphical user interface (GUI) 600 of the image-reorganizing program 1122 includes buttons 602 and 604, fields 606-610, and a work area 620. The work area 620 may include one or more LED cabinet icons 630, where the size and position of each LED cabinet icon corresponds to the resolution and position of each of the display panels 130A and 130B. The user may user the mouse (or touch) in the work area 620 to drag any one of the LED cabinet icons 630. The coordinates of the upper-left vertex of the work area 620 is (0, 0), and each LED cabinet icon 630 includes a number (No.) and the coordinates of the LED cabinet icon 630 (i.e., with reference to the coordinates of its upper-left vertex).

For example, the user may fill the pixel width and pixel height of the LED cabinet in the fields 606 and 608, respectively. The user may also fill the rotation angle and the rotation direction below it in the field 610 (e.g., right turn or left turn). In addition, the user may also use the mouse to click the button 602 in the GUI 600 to add a new LED cabinet icon 630 in the work area 620, wherein the pixel width, pixel height, and rotation angle of the newly added LED cabinet icon 630 follows the values in the fields 606, 608, and 610, respectively.

As shown in FIG. 6B, assuming that there is only one LED cabinet icon 630 in the work area 620 originally, and its number is 1, when the user uses the mouse to click the button 602 in the GUI 600, a new LED cabinet icon 630 is added to the upper-left region of the work area 620, and its number is 2, and its coordinates are (0, 0) at this time. The user may use the mouse to click the LED cabinet icon 630 numbered 2, and drag it to an appropriate position, such as corresponding to the LED cabinet icon 630′. Meanwhile, the coordinates of the LED cabinet icon 630 numbered 2 will change from (0, 0) to (300, 135).

As shown in FIG. 6C, the user may user a similar method to sequentially add a plurality of LED cabinet icons 630, such as numbered 3 to 5. The user may also click the LED cabinet icon 630 numbered 5 in the work area 620, and drag it to an appropriate position, such as corresponding to the LED cabinet icon 630′. At this time, the coordinates of the LED cabinet icon 630′ numbered 5 are changed from (0, 0) to (300, 540).

Next, as shown in FIG. 6D, the user has clicked the LED cabinet icon 630 numbered 5 in the work area 620. When the user fills in 90 in the field 610 and chooses to turn right, the LED cabinet icon 630 numbered 5 will turn 90 degrees to the right, for example, corresponding to the LED cabinet icon 630′. At this time, the coordinates of the LED cabinet icon 630′ numbered 5 will be changed from to (405, 540).

In view of the above, an image-processing device and a display-control method for use in a display-wall system are provided, which are capable of reorganizing the sub-image required for playback on easy display panel in the display wall to obtain the display frame to avoid sending unnecessary sub-images to the display-control device, and thus the bandwidth required for the transmission of image data between the image-processing device and the display-control device can be saved. In addition, the display-control device can extract the sub-image corresponding to each display panel from the display frame according to the display-setting profile of each display panel, and display the extracted sub-image on the corresponding display panel. Accordingly, the display-wall system in the disclosure can reduce the number of required display-control devices.

The use of terms such as “first”, “second”, and “third” in claims is used to modify elements in the claims, and is not used to indicate that there is a priority order, antecedent relationship, or Is an element preceded by another element, or a chronological order when performing a method step, only used to distinguish elements with the same name.

While the disclosure has been described by way of example and in terms of the preferred embodiments, it should be understood that the disclosure is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. An image-processing device, for use in a display-wall system, wherein the display-wall system comprises a plurality of display panels, and the display panels are connected to a display-control device, and the display-control device is connected to the image-processing device, the image-processing device comprising:
a storage device, configured to store an image-reorganizing program; and
a processor, configured to execute the image-reorganizing program to perform the following steps:
receiving a video image;
dividing the video image into a plurality of sub-images;
reorganizing the sub-images corresponding to the display panels into a display frame;
transmitting the display frame and a display-setting profile of each display panel to the display-control device;
utilizing the display-control device to extract the sub-images corresponding to the display panels from the display frame according to the display-setting profile of each display panel, and to display each extracted sub-image on the corresponding display panel.

2. The image-processing device as claimed in claim 1, further comprising: a video-frame buffer and a display-frame buffer, and the processor decodes a video file to obtain the video image.

3. The image-processing device as claimed in claim 2, wherein the display panels are divided into a first group and a second group, and the first group and the second group are connected to a first physical port and a second physical port of the display-control device in series, respectively.

4. The image-processing device as claimed in claim 3, wherein the display panels in the first group have a first scanning direction, and the display panels in the second group have a second scanning direction, and the first scanning direction is perpendicular to the second scanning direction.

5. The image-processing device as claimed in claim 3, wherein the display-setting profile of each display panel comprises a physical-port identifier and a serial-connection position of each display panel, a first start X-axis coordinate and a first start Y-axis coordinate of the sub-image corresponding to each display panel, a first pixel width and a first pixel height of the sub-image to be displayed on each display panel, a rotation angle and a rotation direction of each display panel, a pixel width and a pixel height of each display panel, a second start X-axis coordinate and a second start Y-axis coordinate of the sub-image corresponding to each display panel in a display-frame buffer, and a second pixel width and a second pixel height of the sub-image for each display panel in the display-frame buffer.

6. The image-processing device as claimed in claim 2, wherein the video-frame buffer comprises a first region and a second region, and the processor writes the decoded video image in one of the first region and the second region in turn, and reads the video image from the other one of the first region and the second region,
wherein the display-frame buffer comprises a third region and a fourth region, and the processor writes the sub-image corresponding to each display panel in one of the third region and the fourth region in turn, and reads the display frame from the other one of the third region and the fourth region.

7. The image-processing device as claimed in claim 6, wherein a first resolution of the sub-image for each display panel is equal to a second resolution of each display panel.

8. The image-processing device as claimed in claim 7, wherein the first resolution is x*y pixels, and the processor extracts a plurality of second sub-images having a third resolution of (x+z)*(y+z) pixels corresponding to the sub-images from the video image, and x, y, and z are positive integers.

9. The image-processing device as claimed in claim 8, further comprising: an encoding-frame buffer, and the encoding-frame buffer comprises a fifth region and a sixth region,
wherein the processor reorganizes the second sub-images into an encoding image, writes the encoding image to one of the fifth region and the sixth region in turn, and reads the encoding image from the other one of the fifth region and the six region,
wherein the processor encodes the encoding image at different time points into the video file.

10. The image-processing device as claimed in claim 9, wherein in response to opening the video file, the processor decodes the video file to obtain the encoded image, and extracts the sub-images from the second sub-images in the encoded image.

11. The image-processing device as claimed in claim 1, wherein the display-setting profile of each display panel is adjusted by a graphical interface of the image-reorganizing program,
wherein the graphical interface comprises a plurality of icons corresponding to the display panels, and first positions of the icons on the graphical interface correspond to second positions of the display panels.

12. The image-processing device as claimed in claim 11, wherein in response to inputting a specific icon associated with a specific display on the graphical interface to adjust the first position of the specific icon, the image-reorganizing program correspondingly adjusts the display-setting profile of the specific display panel.

13. A display-control method, for use in an image-processing device, the method comprising:
receiving a video image to be displayed on a plurality of display panels, wherein the display panels are connected to a display-control device;
dividing the video image into a plurality of sub-images;
reorganizing the sub-images corresponding to the display panels into a display frame;
transmitting the display frame and a display-setting profile of each display panel to the display-control device; and
utilizing the display-control device to extract the sub-images corresponding to the display panels from the display frame according to the display-setting profile of each display panel, and displaying each extracted sub-image on the corresponding display panel.

14. The method as claimed in claim 13, wherein the image-processing device comprises a video-frame buffer and a display-frame buffer.

15. The method as claimed in claim 14, wherein the display panels are divided into a first group and a second group, and the first group and the second group are connected to a first physical port and a second physical port of the display-control device in series, respectively.

16. The method as claimed in claim 15, wherein the display panels in the first group have a first scanning direction, and the display panels in the second group have a second scanning direction, and the first scanning direction is perpendicular to the second scanning direction.

17. The method as claimed in claim 15, wherein the display-setting profile of each display panel comprises a physical-port identifier and a serial-connection position of each display panel, a first start X-axis coordinate and a first start Y-axis coordinate of the sub-image corresponding to each display panel, a first pixel width and a first pixel height of the sub-image to be displayed on each display panel, a rotation angle and a rotation direction of each display panel, a pixel width and a pixel height of each display panel, a second start X-axis coordinate and a second start Y-axis coordinate of the sub-image corresponding to each display panel in a display-frame buffer, and a second pixel width and a second pixel height of the sub-image for each display panel in the display-frame buffer.

18. The method as claimed in claim 14, wherein the video-frame buffer comprises a first region and a second region, and the display-frame buffer comprises a third region and a fourth region, and the method further comprises:
decoding the video file to obtain the video image, writing the decoded video image in one of the first region and the second region in turn, and reading the video image from the other one of the first region and the second region; and
writing the sub-image corresponding to each display panel in one of the third region and the fourth region, and reading the display frame from the other one of the third region and the fourth region.

19. The method as claimed in claim 18, wherein a first resolution of the sub-image for each display panel is equal to a second resolution of each display panel.

20. The method as claimed in claim 19, wherein the first resolution is x*y pixels, and the method further comprises:
extracting a plurality of second sub-images having a third resolution of (x+z)*(y+z) pixels corresponding to the sub-images from the video image, wherein x, y, and z are positive integers.

21. The method as claimed in claim 20, wherein the image-processing device further comprises an encoding-frame buffer, and the encoding-frame buffer comprises a fifth region and a sixth region, and the method further comprises:
reorganizing the second sub-images into an encoding image, writing the encoding image to one of the fifth region and the sixth region in turn, and reading the encoding image from the other one of the fifth region and the six region; and
encoding the encoding image at different time points into the video file.

22. The method as claimed in claim 21, further comprising:
in response to opening the video file, decoding the video file to obtain the encoded image, and extracting the sub-images from the second sub-images in the encoded image.

23. The method as claimed in claim 13, wherein the display-setting profile of each display panel is adjusted by a graphical interface of the image-reorganizing program,
wherein the graphical interface comprises a plurality of icons corresponding to the display panels, and first positions of the icons on the graphical interface correspond to second positions of the display panels.

24. The method as claimed in claim 23, further comprising:
in response to inputting a specific icon associated with a specific display on the graphical interface to adjust the first position of the specific icon, correspondingly adjusting the display-setting profile of the specific display panel.
